(19) United States
(12) Patent Application Publication
(10) Pub. No.: US 2013/0221762 A1
(43) Pub. Date: Aug. 29, 2013

(54) ELECTROMAGNETIC SHIELDING MATERIAL

(71) Applicant: Rong-Tai Hong, Kaohsiung City (TW)

(72) Inventor: Rong-Tai Hong, Kaohsiung City (TW)

(21) Appl. No.: 13/403,981

(22) Filed: Feb. 23, 2012

(51) Int. Cl. H02H 11/00

(52) U.S. Cl. 307/326

(57) ABSTRACT

An electromagnetic wave isolation device includes an isolation layer, a first substrate layer and a second substrate layer. The isolation layer has a first surface and a second surface. The isolation layer is doped with metallic particles. The first substrate layer is adhered to the first surface of the isolation layer, and the second substrate layer is adhered to the second surface of the isolation layer. The metallic particles doped in the isolation layer form a protection net for blocking electromagnetic waves. The device of the present invention can be formed as pieces of various shapes. Thus, the production cost of the present invention is reduced, while the practicability thereof is increased.

### BACKGROUND OF THE INVENTION

1. Field of the Invention

The present invention relates to an isolation device, and in particular to an electromagnetic wave isolation device capable of blocking electromagnetic waves efficiently.

2. Description of Prior Art

Since there are various electronic appliances used in our daily life, electromagnetic waves surround our environment. Although there is still no research reports to prove that electromagnetic waves are harmful to human bodies, a research made by Savitz et. al of the University of North Carolina in 1983 shows that a baby exposed to a magnetic field of 60 Hz for a long period of time or wrapped by an electric blanket suffers from cancer 1.3 times than ordinary babies and suffer from leukemia cancer or brain tumor 2.5 than ordinary babies. Further, in 1987, Savitz et al. of the University of North Carolina indicate that radiobroadcasters and radar operators are in more danger to suffer from leukemia cancer than ordinary people.

According to the United Daily News on 5 Apr. 2000, British Customer Association indicates in “Which” magazine that: people who use hand-free handset is exposed to a magnetic filed three times than people who use a mobile phone directly. Sometimes, excessive magnetic waves make people uncomfortable and people may thus suffer from various morbid changes. Such a phenomenon becomes more serious when people use a mobile phone. Thus, some scholars think that electromagnetic waves are really harmful to human bodies. Further, the degree of hazard of the electromagnetic waves to a human body is in proportion to the time period during which he/she is exposed to.

In addition to the mobile phones, computers, television sets and even electric fans can generate electromagnetic waves in our daily life. The conventional electromagnetic wave isolation device is designed as an electromagnetic wave isolation patch which can be adhered to a person using a mobile phone. Such an electromagnetic wave isolation patch is made of an electric-conductive rubber or metallic piece to thereby generate an effect of blocking electromagnetic waves. However, the electric-conductive rubber has a larger cost, and thus it is not suitable to be formed as a large-sized patch. On the other hand, since the electric-conductive rubber is rigid and not air-permeable, the user will feel uncomfortable when in use and the sound of the mobile phone penetrating the electric-conductive rubber is smaller. Thus, the practicability of such a conventional electromagnetic wave isolation device is limited.

FIG. 1 shows an electromagnetic wave isolation patch available in the market, which is adhered to the door of a microwave oven or a mobile phone. A main body 1 of the electromagnetic wave isolation patch includes a stainless wire layer 12 and a fabric layer 11 adhered to each other by adhesive. The stainless wire layer 12 is oriented to face the user. Since the electromagnetic wave isolation patch is constituted of two adhered layers, the effect of screening electromagnetic waves is insufficient. If the patch is not fixed well, the two layers may be separated. Further, bonding two different layers increases the production cost of the patch. Therefore, there is still room for improvement in such a conventional electromagnetic wave isolation patch.

### SUMMARY OF THE INVENTION

In order to solve the above problems, an objective of the present invention is to provide an electromagnetic wave isolation device including an isolation layer, a first substrate layer and a second substrate layer.

The isolation layer has a first surface and a second surface. The isolation layer is doped with a plurality of metallic particles. The first substrate layer is adhered to the first surface of the isolation layer. The second substrate is adhered to the second surface of the isolation layer.

The present invention has the following advantageous features. Since the isolation layer is doped with a plurality of metallic particles, these metallic particles form a protection net for blocking electromagnetic radiation and electromagnetic waves. Further, the electromagnetic wave isolation device can be formed into a piece of various shapes. In this way, the product cost of the electromagnetic wave isolation device is reduced. The practicability of the present invention is increased. Further, the first substrate layer and the second substrate layer can be printed with patterns, which increases the aesthetic and decorative effects of the present invention.

### BRIEF DESCRIPTION OF THE DRAWINGS

FIG. 1 is a schematic view showing a conventional electromagnetic wave isolation patch available in the market;

FIG. 2 is an exploded perspective view showing the electromagnetic wave isolation device according to a first embodiment of the present invention;

FIG. 3 is an assembled cross-sectional view showing the first embodiment of the present invention;

FIG. 4 is an assembled cross-sectional view showing the electromagnetic wave isolation device according to a second embodiment of the present invention;

FIG. 5 is a schematic view showing an apron having the electromagnetic wave isolation device of the present invention and worn by a user; and

FIG. 6 is a schematic view showing an upper garment having the electromagnetic wave isolation device of the present invention and worn by a user.

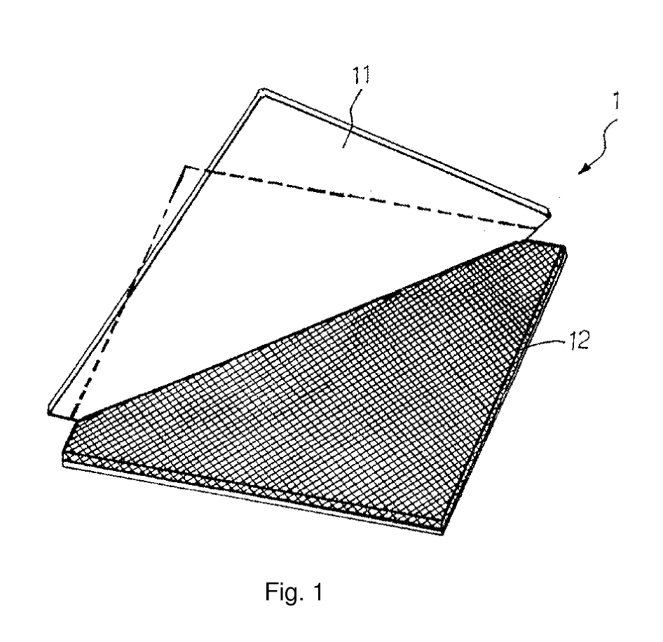

### DETAILED DESCRIPTION OF THE INVENTION

The features and technical contents of the present invention will be described in more detail with reference to two preferred embodiments thereof shown in the accompanying drawings.

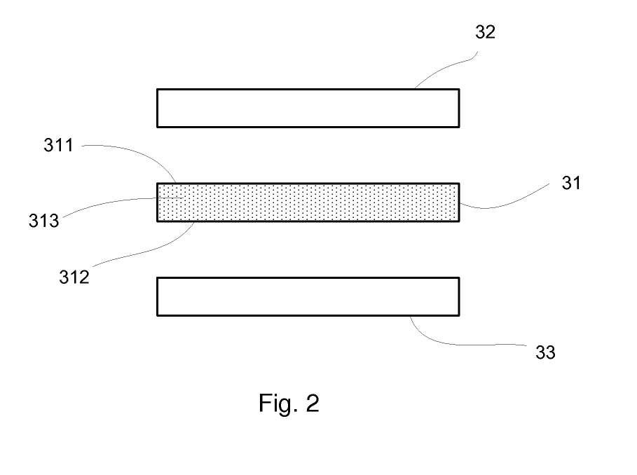

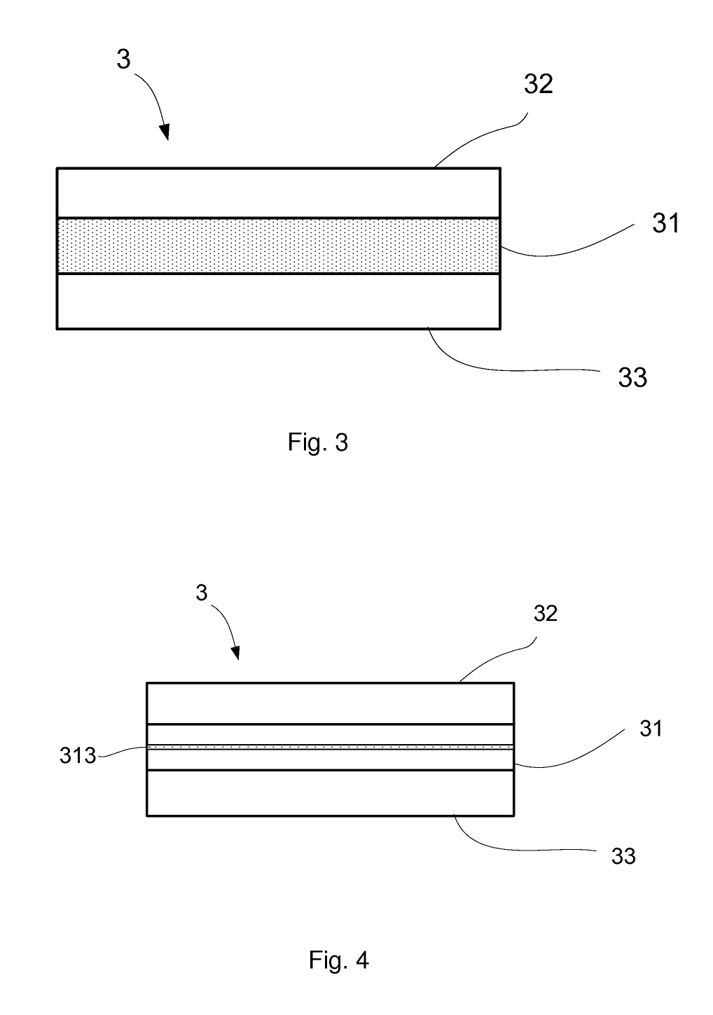

Please refer to FIGS. 2 and 3 showing an electromagnetic wave isolation device 3 of the first embodiment of the present invention, which includes an isolation layer 31, a first substrate layer 32, and a second substrate layer 33.

The isolation layer 31 has a first surface 311 and a second surface 312 opposite to the first surface 311. The isolation layer 31 is doped with a plurality of metallic particles 313. In the first embodiment, the isolation layer 31 is made of a material selected from polyethylene terephthalate (PET), polyethylene (PE), oriented polypropylene (OPP), corrugated polypropylene (CPP), glues, lacquer, foamed plastic and compounds thereof. The metallic particles 31 are selected from steel, polished metal, Fe, Co, Ni, any metals that can be magnetized, and powder of the mixtures thereof.

The first substrate layer 32 is adhered to the first surface 311 of the isolation layer 31. The second substrate layer 33 is adhered to the second surface 312 of the isolation layer 31. In the first embodiment, the first substrate layer 32 and the second substrate layer 33 may be made of fibers, leather or nonwoven fabrics.

In practical manufacturing, Fe, polished metal, or other metals are grounded into tiny particles. Then, the tiny particles are mixed with glues or lacquer to form a mixture. The mixture is poured into a mold and dried in a baking oven to become a solid semi-product. Thereafter, the first substrate layer 32 and the second substrate layer 33 are adhered to the semi-product to form the final product. Of course, when isolation layer 31 is not dried and hardened, such a liquid-phase gel-like isolation layer 31 can be adhered to the first substrate layer 32 and the second substrate layer 33, thereby saving the expense of adhesive used between the interferences of different materials in prior art. It can be seen from FIG. 3 that, in a first embodiment, the metallic particles 313 are well mixed and distributed in the isolation layer 31.

It should be noted that, based on deliberate experiments, the present Inventor proves that the isolation layer 31 can block the electromagnetic wave as long as its thickness is larger than 1 mm. Of course, the thickness of the isolation layer 31 may be changed according to the strength of the electromagnetic waves to be blocked.

Please refer to FIG. 4, which shows the electromagnetic wave isolation device 3 of the second embodiment. Similarly, the electromagnetic wave isolation device 3 comprises the isolation layer 31, the first substrate layer 32 and the second substrate layer 33. The redundant description is omitted thereto for simplicity and the difference between the second embodiment and the first embodiment is described only. In practical manufacturing, the plurality of metallic particles 313 are applied onto the surface of the isolation layer 31 by a sandblasting process, thereby forming a metallic film. Then, another isolation layer 31 is coated. When the isolation layer 31 is not hardened completely, the first substrate layer 32 and the third substrate layer 33 are adhered to such a liquid-phase gel-like isolation layer 31 respectively, thereby simplify the manufacturing process. Since the plurality of metallic particles 313 are wrapped in the gel-like isolation layer 31, the final product has a high yield and is durable without maintenance. It can be seen from FIG. 4 that, according to the second embodiment of the present invention, the plurality of metallic particles 313 are formed as thin pieces and concentrated in the isolation layer 31.

In the electromagnetic wave isolation device 3 of the present embodiment, the isolation layer 31 is sandwiched between the first substrate layer 32 and the second substrate layer 33 to form a main body of the electromagnetic wave isolation device 3. The metallic particles 313 in the isolation layer 31 are magnetic metals. Thus, when the distribution concentration of the metallic particles 31 achieves a desired value, the metallic particles 313 in the isolation layer 31 generate a sufficient effect of blocking the electromagnetic waves. The present invention has a simple structure and an improved practicability. Further, the production cost of the present invention is reduced.

The first surface 311 and the second surface 312 of the isolation layer 31 are adhered to the first substrate layer 32 and the second substrate layer 33 respectively. The first substrate layer 32 and the second substrate layer 33 are made of soft cloth, so that the electromagnetic wave isolation device 3 of the present invention can be made as an article that can be worn by a user and is air-permeable.

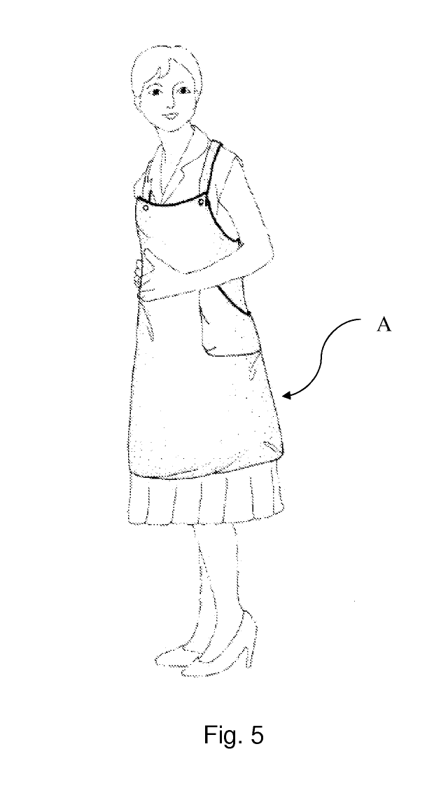

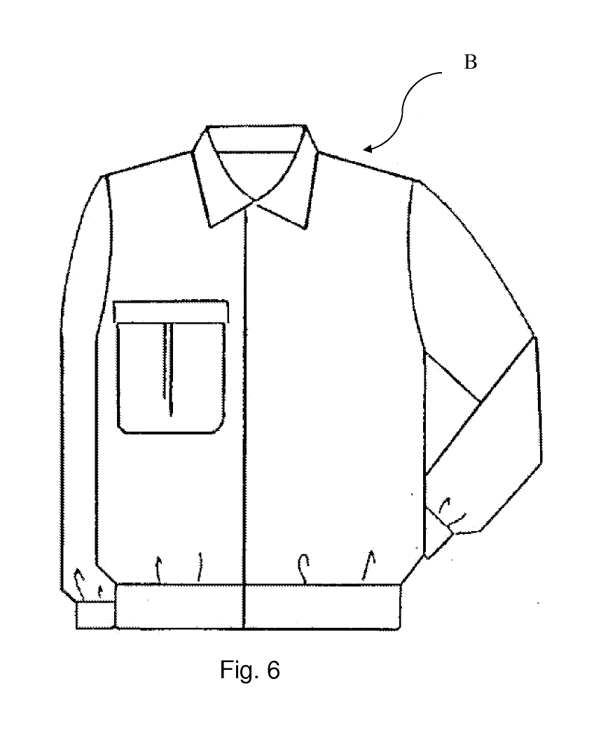

Please refer to FIGS. 5 and 6. When the first substrate layer 32 and the second substrate layer 33 of the present invention are made of soft woven fabrics, they can be adhered to the isolation layer 31 to form the electromagnetic wave isolation device 3. Then, the device 3 is stitched to form an apron ‘A’ or upper garment ‘B’. Such an electromagnetic wave isolation device 3 has a sufficient softness and flexibility, so that it is very comfortable for the user to wear. Further, the first substrate layer 32 and the second substrate layer 33 can be printed with patterns, thereby increasing the aesthetic and decorative effects of the present invention. In addition to the first substrate layer 32 and the second substrate layer 33, other substrate layers may be increased based on the properties of an article to be worn by the user.

In the electromagnetic wave isolation device 3 of the present embodiment, the isolation layer 31 is constituted of metallic particles 313 for blocking electromagnetic waves. The first substrate layer 32 and the second substrate layer 33 are soft and can be made as an article worn by a user. In manufacturing, the metallic particles 313 can be directly wrapped in rubber, so that the electromagnetic wave isolation device 3 can be formed as pieces of various shapes. Thus, the production cost of the present invention is reduced, and the practicability thereof is increased.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An electromagnetic wave isolation device, including:
an isolation layer having a first surface and a second surface, the isolation layer being doped with a plurality of metallic particles;
a first substrate layer adhered to the first surface of the isolation layer; and
a second substrate layer adhered to the second surface of the isolation layer.

2. The electromagnetic wave isolation device according to claim 1, wherein the isolation layer is made of a material selected from polyethylene terephthalate (PET), polyethylene (PE), oriented polypropylene (OPP), corrugated polypropylene (CPP), glues, lacquer, foamed plastic and compounds thereof.

3. The electromagnetic wave isolation device according to claim 2, wherein the metallic particles are selected from steel, Fe, polished metal, Co, Ni other metals that can be magnetized, and compounds thereof.

4. The electromagnetic wave isolation device according to claim 3, wherein the metallic particles are mixed and distributed in the isolation layer.

5. The electromagnetic wave isolation device according to claim 3, wherein the metallic particles are formed into thin pieces and concentrated in the isolation layer.

6. The electromagnetic wave isolation device according to claim 1, wherein the thickness of the isolation layer is larger than 1 mm.

7. The electromagnetic wave isolation device according to claim 3, wherein the first substrate layer and the second substrate layer are made of fibers.

8. The electromagnetic wave isolation device according to claim 3, wherein the first substrate layer and the second substrate layer are made of leather.

9. The electromagnetic wave isolation device according to claim 3, wherein the first substrate layer and the second substrate layer are made of nonwoven fabrics.
